(19) United States
(12) Patent Application Publication
(10) Pub. No.: US 2009/0234040 A1
(43) Pub. Date: Sep. 17, 2009

(54) ACTIVE ENERGY RAY-CURABLE INK COMPOSITION, STORAGE CONTAINER FOR ACTIVE ENERGY RAY-CURABLE INK COMPOSITION, AND METHOD FOR STORING ACTIVE ENERGY RAY-CURABLE INK COMPOSITION

(76) Inventor: Satoshi Masumi, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/065,458

(22) PCT Filed: Aug. 18, 2006
(86) PCT No.: PCT/JP2006/316213

§ 371 Date: Feb. 29, 2008

(30) Foreign Application Priority Data
Sep. 5, 2005 (JP) 2005-256225

(51) Int. Cl. C09D 11/10

(52) U.S. Cl. 522/78

(57) ABSTRACT

Disclosed is an active energy ray-curable ink composition containing at least a cationically polymerizable compound which is curable with an active energy ray and a pigment. This active energy ray-curable ink composition is characterized in that a vinyl ether compound is contained as the cationically polymerizable compound, the vinyl ether compound content relative to the total of the cationically polymerizable compound is not less than 45% by mass, and the pigment is composed of C.I. Pigment Red 122. This active energy ray-curable ink composition is excellent in storage stability while containing a cationically polymerizable compound which can be cured with an active energy ray. Also disclosed are a storage container for such an active energy ray-curable ink composition and a method for storing such an active energy ray-curable ink composition.

### TECHNICAL FIELD

The present invention relates to an active energy ray-curable ink composition incorporating a cationically polymerizable compound capable of being cured via active energy rays, of which storage stability and curability are improved, as well as to a storage container and a storage method of the same.

### TECHNICAL BACKGROUND

In recent years, soft packages are printed employing gravure printing systems or flexographic printing systems. With regard to such gravure printing and flexographic printing, cost has been lowered and delivery period after an order has also been shortened due to innovations of the production system. However, production of press plates requires a longer time and a higher cost, and density stabilization after initiation of printing also requires a longer time. Accordingly, in the case of production of samples (trial products, products for exhibition, and products for limited sale) in small quantities, a large amount of eventual loss is produced, whereby the resulting unit price increases. Further, recently, some of the wet type electrophotographic systems make it possible to prepare samples employing soft packaging film. However, such systems are not capable of efficiently corresponding to small lots due to long duration for level regulation during start-up and insufficient durability of printed images. It has become common that with regard to the ink-jet recording systems for soft packaging, after packaging, packaging date and best-before date are printed in white or black. However, it is not common that text, design pictures and photographic images are recorded directly.

Recently, on the other hand, ink-jet recording systems, which enable simple and low cost production of images, have been applied to photography, various types of printing, marking, and special printing such as color filters. Specifically, by employing a recording apparatus which ejects and controls minute ink droplets, inks which exhibit an improved color reproduction range, durability, and ejection suitability, and exclusive paper which has been subjected to significant enhancement of absorbability, color formation of colorants, and surface glossiness, it has become possible to realize image quality comparable to that of silver halide photography.

Further, in recent printing systems, the active light ray-curable type inks, represented by an ultraviolet ray-curable type ink, exhibit advantages such as excellent rapid drying properties, no need of a drying process employing heat, as well as non-environmental pollution and high safety due to the solvent-free type. Specifically, in ink-jet recording systems, in order to realize high image quality, exclusive paper is needed as a recording medium. However, by employing an active energy ray-curable type ink, usable recording media are less limited, and it is possible to form images onto a wide variety of recording media and to still realise high image quality.

Initially, as an active light ray-curable type ink, active light-curable type ink employing radically polymerizable monomers was the mainstream due to a wide selection of raw materials. Recently, however, in view of inhibition of curing due to oxygen, an active light ray-curable type ink, employing cationically polymerizable monomers, has attracted increased attention.

However, though the active energy ray-curable type ink-jet ink, which employs cationically polymerizable monomers, wherein a photolytically generated acid is employed as a catalyst, is free from polymerization inhibition due to oxygen, a problem is involved such as susceptibility to effects of molecular level moisture (humidity). Further, in image formation via ink-jet recording systems or flexographic printing systems which employ the cationically active energy ray-curable type ink-jet ink, ink which exhibits low viscosity and excellent storage stability has been demanded.

A method is proposed in which vinyl ether compounds are employed as a cationically polymerizable compound of low viscosity (refer, for example, to Patent Documents 1 and 2). However, in these patent documents, even though stable ejection is enabled while accompanying a decrease in viscosity, neither description nor suggestion is found with regard to a method to improve the storage stability of ink incorporating cationically polymerizable compounds.

Patent Document 1: JP-A 2005-154734 (claims and examples)

Patent Document 2; JP-A H09-183328 (page 2 and examples)

### DISCLOSURE OF THE INVENTION

### Technical Problem to be Dissolved

In view of the foregoing, the present invention was achieved. An object of the present invention is to provide an active energy ray-curable ink composition exhibiting excellent storage stability, which incorporates an active light ray-curable cationically polymerizable compound, as well as a storage container and a storage method thereof.

Another object of the present invention is to provide an active energy-curable ink composition exhibiting excellent discharge stability and storage stability, which incorporates an active light ray-curable cationically polymerizable compound when employed in an ink-jet recording, as well as a storage container and a storage method thereof.

### Means to Dissolve the Problem

The above objects of the present invention are achievable via the following embodiments.

1. In an active energy ray-curable ink composition which comprises at least an active light ray-curable cationically polymerizable compound and a pigment, an active energy ray-curable ink composition which is characterised in that the active energy ray-curable ink composition comprises a vinyl ether compound as the aforesaid cationically polymerizable compound, the content of the aforesaid vinyl ether compound is at least 45% by weight with respect to the total of the aforesaid cationically polymerizable compound, and the aforesaid pigment is C.I. Pigment Red 122.
2. The active energy ray-curable ink composition, described in 1, which is characterised in that the aforesaid vinyl ether compound is the compound represented by following Formula (A):

R₁-X-(R₂)ₙ Formula (A)

wherein R₁ represents a vinyl ether containing group, R₂ represents a substituent, X represents a ring structure containing group, and “n” represents an integer of 0 or higher.
3. The active energy ray-curable ink composition, described in 1. or 2., which is characterized in that a cationic polymerization initiator is further incorporated.
4. The active energy ray-curable ink composition, described in any of 1.-3, which is characterized in that an oxirane ring containing compound or an oxetane ring containing compound is incorporated as the aforesaid cationically polymerizable compound.
5. In a storage container of an active energy ray-curable ink composition, a storage container of an active energy ray-curable ink composition which is characterised in that the active energy ray-curable ink composition, described in any one of 1-4, is incorporated.
6. A storage method of an active energy ray-curable ink composition which is characterized in that the storage container of an active energy ray curable ink composition, described in 5. is employed.

### ADVANTAGE OF THE INVENTION

According to the present invention, it is possible to provide an active energy ray-curable composition, exhibiting excellent storage stability, which incorporates active light ray-curable cationically polymerizable compounds, a storage container, and a storage method thereof. Specifically, when employed in an ink-jet recording method, it is possible to provide an active energy ray-curable ink composition, exhibiting excellent discharge stability and storage stability, which incorporates active light ray-curable cationically polymerizable compounds, as well as a storage container and a storage method thereof.

### THE BEST EMBODIMENT FOR EMBODYING THE INVENTION

The preferred embodiments to realize the present invention will now foe detailed.

In view of the above problems, the inventors of the present invention conducted diligent investigations. As a result, the following was discovered and the present invention was achieved. By employing an active energy ray-curable ink composition, which was characterised in that in an active energy ray-curable ink composition which incorporated at least an active light ray-curable cationically polymerizable compound and a pigment, a vinyl ether compound was incorporated as the aforesaid cationically polymerizable compound, the content of the aforesaid vinyl ether compound was at least 45% by weight with respect to the total weight of the aforesaid cationically polymerizable compound, and the aforesaid pigment was C.I. Pigment Red 122, it was possible to realise an active energy ray-curable ink composition exhibiting excellent discharge stability and storage stability, which incorporated an active light ray-curable cationically polymerizable compound.

The present invention will now be detailed, (Active Light Ray-Curable Cationically Polymerisable Compounds 5

### (Vinyl Ether Compounds)

One of the features of the active energy ray-curable ink composition (hereinafter also referred simply to as the ink composition) of the present invention is incorporation of vinyl ether compounds as an active light ray-curable cationically polymerizable compound in an amount of at least 45% by weight.

Examples of vinyl ether compounds which are applicable to the present invention include di- or trivinyl ether compounds such as ethylene glycol divinyl ether, diethylene glycol divinyl ether, triethylene glycol divinyl ether, propylene glycol divinyl ether, dipropylene glycol divinyl ether, butanediol divinyl ether, hexanediol divinyl ether, cyclohexane dimethanol divinyl ether, or trimethylol propane trivinyl ether, as well as monovinyl ether compounds such as ethyl vinyl ether, n-butyl vinyl ether, isobutyl vinyl ether, octadecyl vinyl ether, cyclohexyl vinyl ether, hydroxybutyl vinyl ether, 2-ethyl hexyl vinyl ether, cyclohexanedimethanol monovinyl ether, n-propyl vinyl ether, isopropyl vinyl ether, isopropenylether-O-propylene carbonate, dodecyl vinyl ether, diethylene glycol monovinyl ether, or octadecyl vinyl ether.

Of these vinyl ether compounds, in view of curability, adhesion, and surface hardness, di- or trivinyl compounds are preferred, and divinyl ether compounds are particularly preferred. In the present invention, the above vinyl ether compounds may be employed individually or in combinations of at least two types.

The present invention is characterized in that the vinyl ether compounds according to the present invention is incorporated in an amount of at least 45% by weight with respect to the total weight of cationically polymerizable compounds incorporated in the ink composition. Specifically, the above content is preferably 45-100% by weight, and when employed for ink-jet recording, the content is preferably 75-100% by weight.

Of the vinyl ether compounds according to the present invention, in view of enhancement of storage stability and curability, which are targeted effects of the present invention, the compounds represented by following Formula (A) are particularly preferred.

R1-X-(R₂)ₙ Formula (A)

In the above Formula (A), R₁ represents a vinyl ether containing group, R₂ represents a substituent, X represents a ring structure containing group, and n represents an integer including 0.

In above Formula (A), listed as the ring structure represented by X are an aliphatic ring, an aromatic ring, and cyclic ether. Of these, in view of curability, preferred is the aliphatic ring.

Specific examples of the vinyl ether compounds represented by Formula (A) are listed below, however the present invention is not limited to these exemplified compounds.

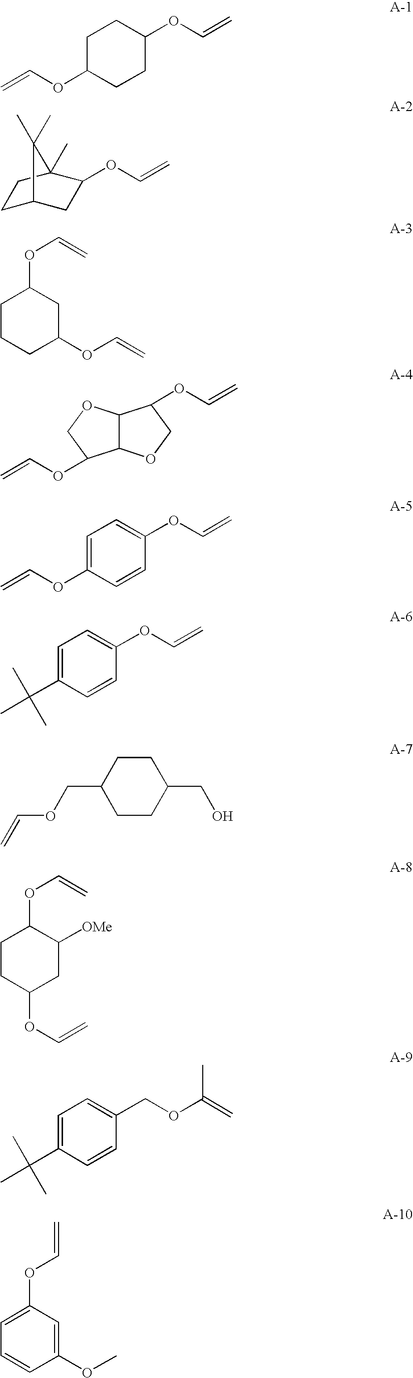

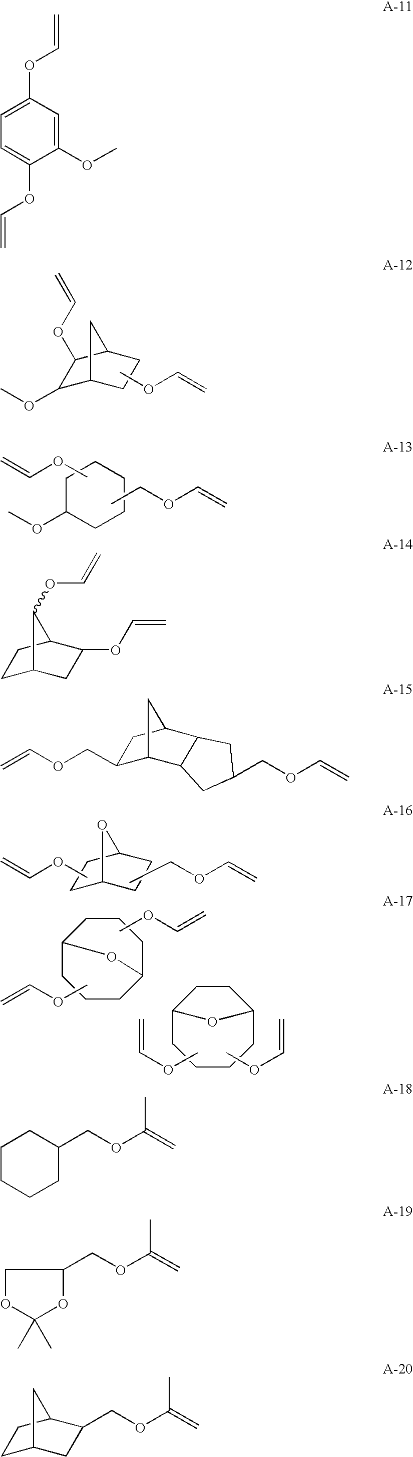

In the ink composition of the present invention, in view of further realization of targeted effects, it is preferable that oxirane ring containing compounds or oxetane ring containing compounds are incorporated together with the vinyl ether compounds according to the present invention.

### (Oxirane Ring Containing Compounds and Oxetane Ring Containing Compounds)

Oxirane ring containing compounds (hereinafter also referred to as epoxy compounds) refer to compounds having an oxirane ring which is the 3-membered ring represented by following Formula (1), and include aromatic epoxy compounds as well as alicyclic epoxy compounds.

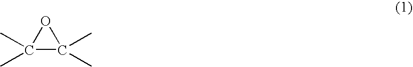

Oxetane ring containing compounds refer to compounds having an oxetane ring which is the 4-membered ring ether represented by following Formula (4).

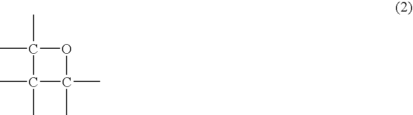

As described above, cationically polymerizable compounds which, are preferably employed together with vinyl ether compounds according to the present invention include alicyclic epoxy compounds and oxetane compounds. In the present invention, it is particularly preferable that alicyclic epoxy compounds and oxetane compounds are further blended and employed since excellent curability is thereby realised.

Preferred oxetane compounds include oxetanes such as 3-ethyl-3-hydroxymethyloxetane, 1,4bis{[(3-ethyl-3-oxetanyl)methoxy]methyl}benzene, 3-ethyl 3-(phenoxymethyl)oxetane, 3-ethyl-3-(2-ethylhexyloxymethyl)oxetane, or di[1-ethyl(3-oxetanyl)]methyl ether.

Preferred alicyclic epoxy compounds include 3,4-epoxycyclohexylmethyl-3′,4′-epoxycyclohexane carboxylate (available under the trade names of UVR 6105, UVR 6110, and CELLOXIDE 2021), bis(3,4-epoxycyclohexylmethyl)adipate (available under a trade name of UVR 6128), vinylcyclohexane monoepoxide (available under the trade name of CELLOXIDE 2000), ε-caprolactone modified 3,4-epoxycyclohexylmethyl-3′,4′-epoxycyclohexane carboxylate (available tinder the trade name of CELLOXIDE 2081), and 1-methyl-4-(2-methyloxylanyl)-7-oxabicyclo[4,1,0]heptane (available under the trade name of CBLLOXIDS 3000). Products under above trade names of WR 6105 and UVR 6123 are available from Dow Chemical Co. Products under the trade names of CBLLOXXDE 2000, CELLOXIDE 2000, CELLOXIDE 2000, and CELLOXIDE 2000 are available from Dicel Chemical Co., Ltd. UVR 6105 and UVR 6110 are low viscosity products.

It is possible to list, as a more preferred alicyclic epoxy compound, the compounds described in paragraphs [0020]-[0029] of JP-A No. 2005-134357.

Specific examples of preferred alicyclic epoxides are listed below, however the present invention is not limited thereto.

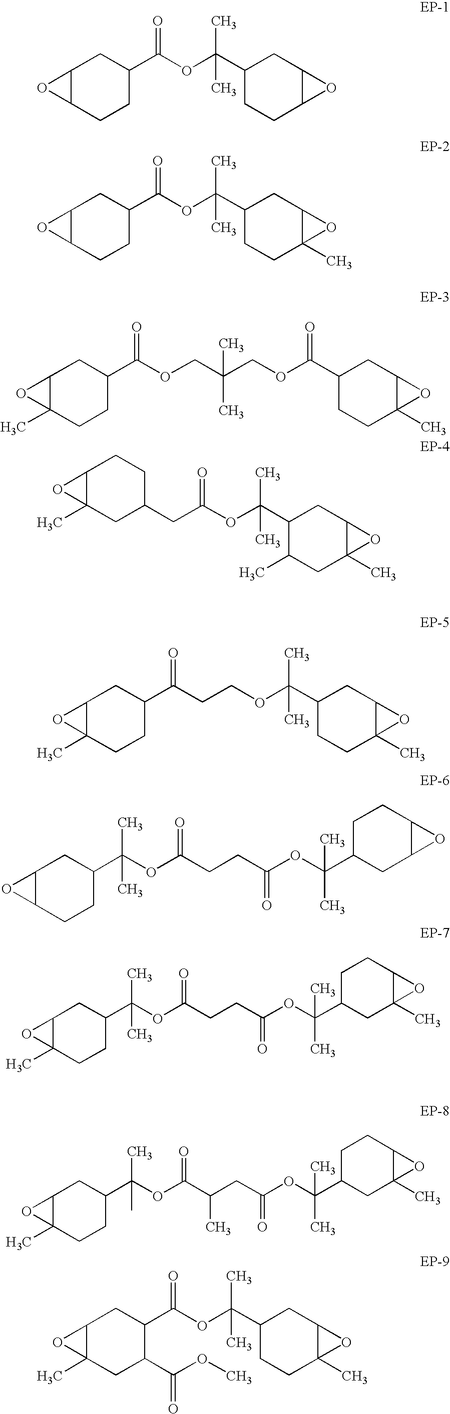

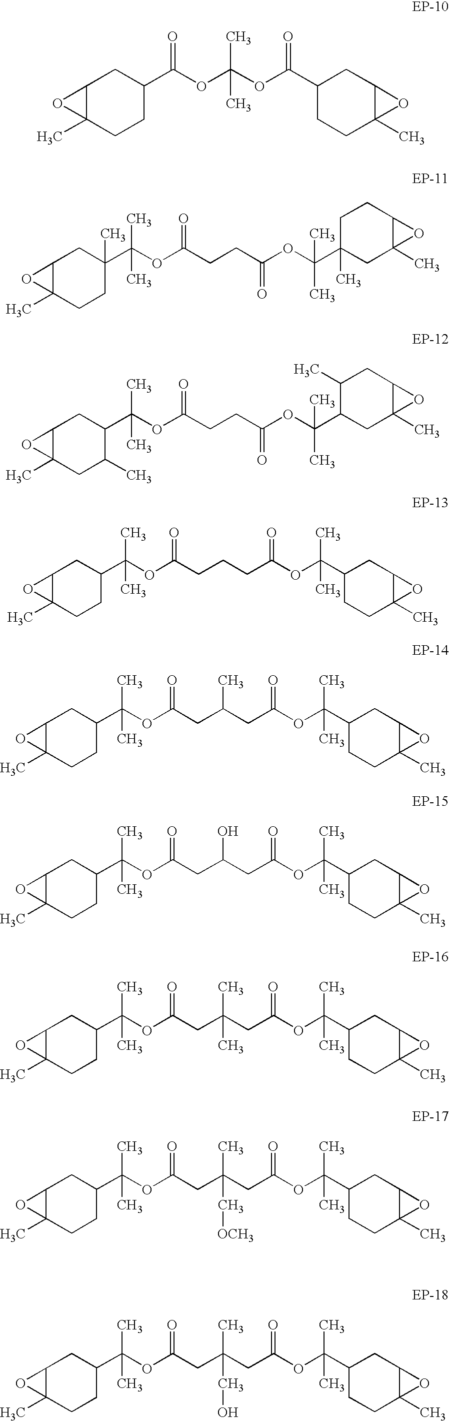

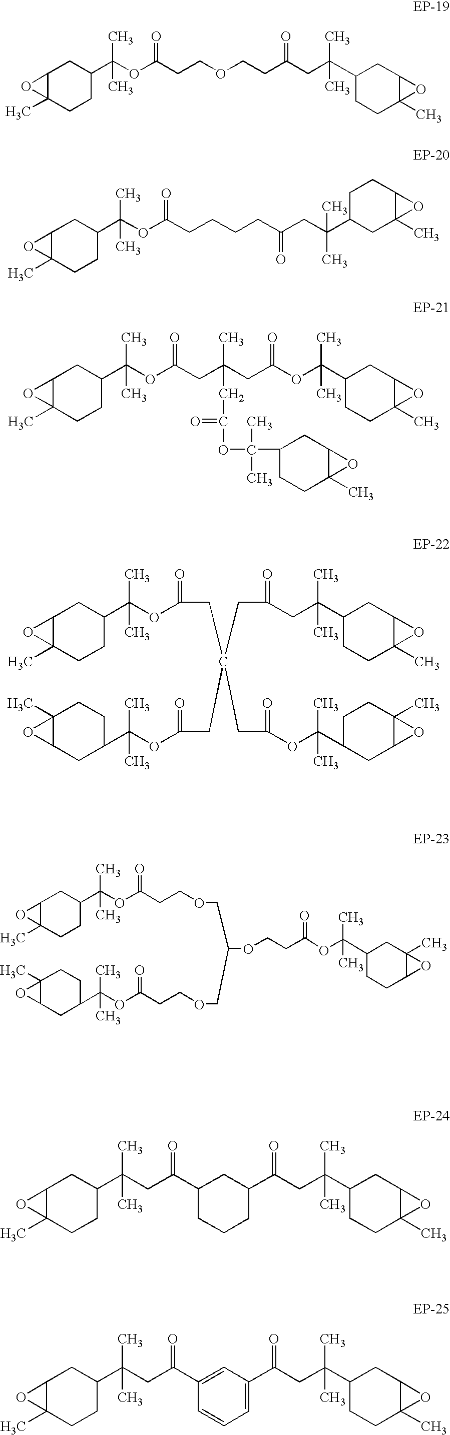

It is possible to synthesize the epoxy compounds according to the present invention based on the methods described, for example, in each of U.S. Pat. Nos. 2,745,847, 2,750,395, 2,853,498, 2,853,499, and 2,863,881.

### (Photopolymerization Initiators)

In the active energy ray-curable ink composition of the present invention, it is preferable that cationic polymerization initiators as a photopolymerization initiator are incorporated together with cationically polymerisable compounds.

Specifically listed as the cationic polymerization initiators may be photolytically acid generating agents. For example, employed are compounds utilized in chemical amplification type photoresists and cationic photopolymerization (refer to pages 187-192 of “Imaging yo Yuuki Zairyo (Imaging Organic Materials)”, edited by Bunshin Shuppan (1993). Examples of appropriate compounds for the present invention will be listed.

First, it is possible to list B(C₅F₅)⁻, PF₆⁻, ASF₆⁻, SBF6-, and CFSO₃— salts of aromatic onium compounds such as diazonium, ammonium, iodonium, sulfonium, or phosphonium.

Specific examples of the usable onium compounds in the present invention will be listed.

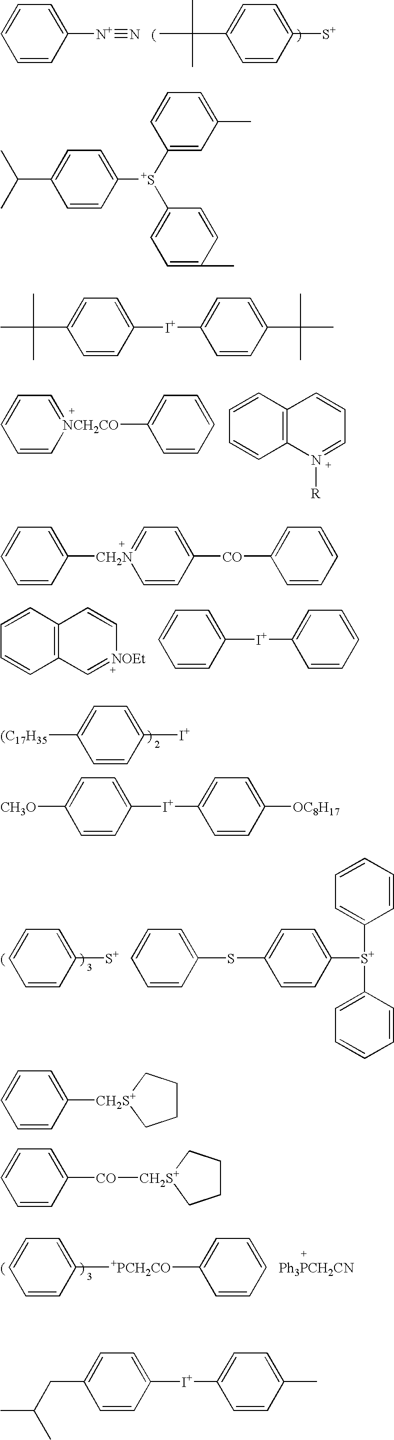

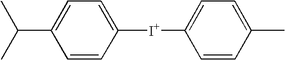

Secondly, it is possible to list sulfonated compounds which generate sulfonic acid. The specific examples are listed below.

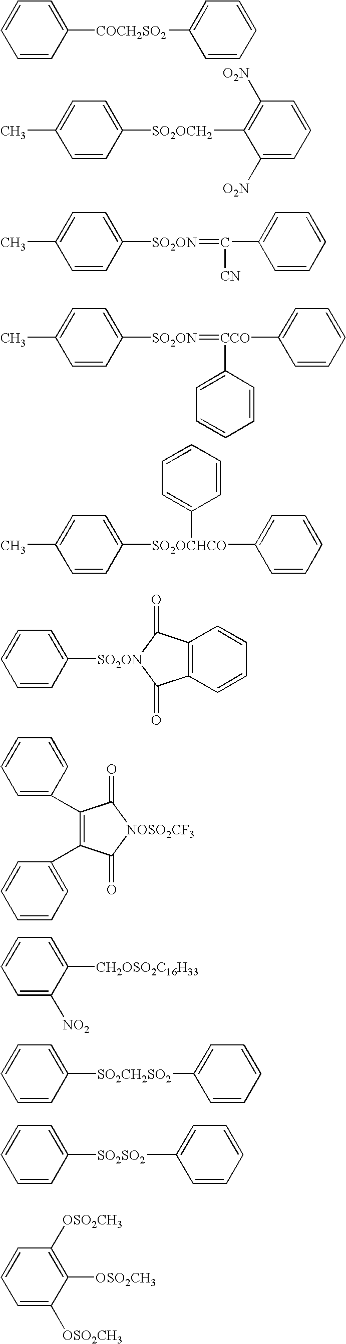

Thirdly, it is possible to employ halogenated compounds which photolytically generate hydrogen halides.

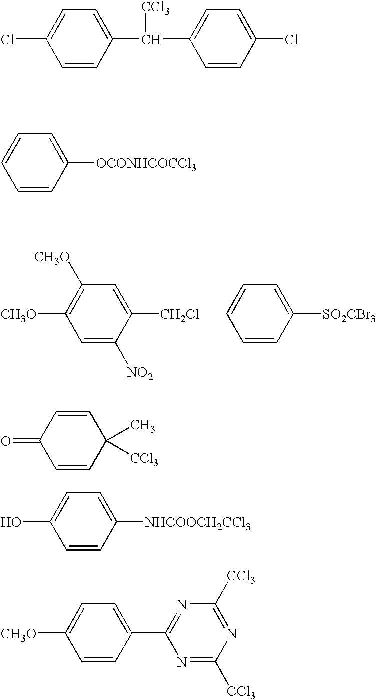

Fourthly, it is possible to list iron arene complexes.

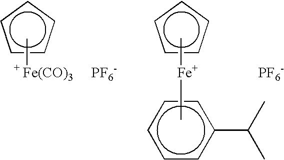

### (Sensitizers)

In the active energy ray-curable ink composition of the present invention, it is preferable to employ sensitizers which absorb ultraviolet ray spectra, at a wavelength equal to or longer than 300 nm. For example, it is possible to list polycyclic aromatic compounds, carbazole derivatives and thioxanthone derivatives, having at least one of an aralkyloxy group or an alkoxy group which may be substituted with a substituent such as a hydroxyl group as a substituent.

As usable polycyclic aromatic compounds in the present invention, preferred are naphthalene derivatives; anthracene derivatives, glycerin derivatives, and phenanthrene derivatives. As alkoxy groups which are employed as a substituent preferred are those having 1-18 carbon atoms, but particularly preferred are those having 1-8 carbon atoms. Aralkyloxy groups are preferably those having 7-10 carbon atoms. As aralkyloxy groups, those having 7-10 carbon atoms are preferred, and a benzoyloxy group and a phenetyl group, both having 7-8 carbon atoms, are particularly preferred.

Examples of usable sensitizers in the present invention include carbazole derivatives such as carbazole, H-ethylcarbazole, N-vinylcarbazole, or N-phenylcarbazole; naphthol derivatives and naphthalene derivatives of condensation products of a naphthol derivatives with formalin, such as 1-naphthol, 2-naphthol, 1-methoxynaphthalene, 1-stearyloxynaphthalene, 2-methoxynaphthalene, 2-dodecyoxynaphthalene, 4-methoxy-1-naphthol, glycidyl-1-naphthyl ether, 2-(2-naphthoxy)ethyl vinyl ether, 1,4-dihydroxynaphthalene, 1,5-dihydroxynaphthalene, 1,6-dihydroxynaphthalene, 2,7-dihydroxynaphthaiene, 2,7-dimethoxynaphthalene, 1,1′-thiobis(2-naphthol), 1,1′-bi-2-naphthol, 1,5-naphnyl diglycidyl ether, 2,7-di(2-vinyioxyethyl)naphthyl ether, 4-methoxy-1-naphthol, ESN-175 (epoxy resin, produced by Shin-Nit tetsu Chemical Co.) and series thereof; anthracene derivatives such as 9,10-dimethoxyanthracene, 2-ethyl-9,10-dimethoxyantharacene, 2-tbutyl-9,10-dimethoxyanthracene, 2,3-dimethyl-9,10-dimethoxyanthracene, 3-methoxy-10-methylanthracene, 9,10-diethoxyanthracene, 2-ethyl-9,10-diethoxyanthracene, 2-tbutyl-9,10-diethoxyanthacene, 2,3-dimethyl-9,10-diethoxyanthracene, 9-ethoxy-10-methylanthracene, 9,10-diproxyanthracene, 2-ethyl-9,10-dipropoxyanthrscene, 2-tbutyl-9,10-dipropoxyanthracene, 2,3-dimethyl-9,10-dipropoxyanthracene, 9-isopropxy-10-methylanthracene, 9,10-dibenzyloxyanthracene, 2-ethyl-9,10-dibenzyloxyanthracene, 2-tbutyl-9,10-dibenzyloxyanthracene, 2,3-dimethyl-9,10-dibenzyloxyanthracene, 9-benzyloxy-10-methylanthracene, 9,10-di-α-methylbenzyloxyanthracene, 2-ethyl-9,10-di-α-methylbenzyloxyanthracene, 2-tbutyl-9,10-di-α-methylbenzyloxyanthracene, 2,3-dimethyl-3,10-di-α-methylbenzyloxyanthracene, 9-(α-methylbenzyloxy)-10-methylanthracene, 9,10-di(2-hydroxyethoxy)anthracene, 2-ethyl-9,10-di(2-caroxyethoxy)anthracene; chrysene derivatives such as 1,4-dimethoxy chrysene, 1,4-diethoxy chrysene, 1,4-dipropoxy chrysene, 1,4-dibenzyloxy chrysene, or 1,4-α-methylbenzyloxy chrysene; and phenanthrene derivatives such as 9-hydroxyphenanthrene, 9,10-dimethoxyphenanthrene, or 9,10-diethoxyphenamthrene. Of these derivatives, preferred are 9,10-dialkoxyanthracene derivatives which may have an alkyl group having 1-4 carbon atoms as a substituent, and a methoxy group and an ethoxy group are preferred as the alkoxy group.

Further listed as thioxanthone derivatives may, for example, be thioxanthone, 2,4-dimethylthioxanthone, 2,4-diethylthioxanthone, isopropylthioxanthone, and 2-chloro thioxanthone.

### (Pigments)

The active energy ray-curable ink composition of the present invention is characterized in that pigments are employed as a colorant and C.I. Pigment Red 122 is employed as the pigment.

In the present invention, by employing C.I. Pigment Red 122 as the pigment together with the vinyl ether compounds according to the present invention, dispersibility at the high concentration of pigments is achieved and simultaneously, it is possible to realise excellent lightfastness of formed magenta images.

Dispersion of C.I. Pigment Red 122 according to the present invention may be carried out employing, for example, a ball mill, a sand mill, an attritor, a roller mill, an agitator, a Henschel mixer, a colloid mill, an ultrasonic homogeniser, a pearl mill, a wet system jet mill, or a paint shaker. Further, when pigments are dispersed, it is also possible to incorporate dispersing agents. It is preferable to employ, as a dispersing agent, polymer dispersing agents which include the SOLSPERSE Series from Avecia Co. and the PB Series from Ajinomoto Fine Techno Co.

C.I. Pigment Red 122 according to the present invention may be subjected, without any modification, to a dispersion treatment based on the above method, and incorporation may be effected in a state of minute pigment particles. However, in view of effective realization of the targeted effects of the present invention, it is preferable that C.I. Pigment Red 122 is subjected to a surface treatment.

Examples of the preferred surface treatments include any of the treatments which make the surface basic, acidic, or polar.

As the surface treatment, it is preferable to employ a synergist which is similar to the structure of C.I. Pigment Red 122 which has been subjected to any of the basic, acidic, or polar treatment.

In the present invention, a synergist refers to one which has a structure similar to C.I. Pigment Red 122, is a dye modified with a polar group such as an acidic group or a basic group, or one which is an organic compound having an organic pigment mother nucleus which is bonded to a polar group directly or via a joint. By adsorbing the above onto the pigment surface to result in bonding to dispersing agents, dispersibility of C.I. Pigment Red 122 is enhanced.

Examples of the polar groups include a sulfonic acid group, a carboxylic acid group, a phosphoric acid group, a boric acid group, and a hydroxyl group. Of these, the sulfonic acid group as well as the carboxylic acid group is preferred, and the sulfonic acid is more preferred.

Methods to prepare minute Pigment Red 122 particles having a polar group on their surface include the method, described, for example, in each of WO97/48769, as well as JP-A Nos. 10-110129, 11-246807, 11-57458, 11-139739, 11-323232, and 2000-265094, in which by treating the surface of pigment particles with appropriate oxidizing agents, polar groups such as a sulfonic acid group or salts thereof are introduced into at least some areas of the pigment surface. Specifically, preparation may be conducted as follows. Carbon black, is oxidized via concentrated nitric acid, and colored pigments are oxidized via sulfamic acid, sulfonated pyridine salts, or amidosulfuric acid in sulfolane or N-methyl-2-pyrrolidone. In these reactions, those which are excessively oxidized to become water-soluble are removed followed by purification, whereby it is possible to prepare a pigment dispersion. Further, when a sulfonic acid group is introduced onto the surface, if needed, the acidic group may foe neutralized employing basic compounds.

Other methods include the method described in JP-A Nos. 11-49974, 2000-273383, and 2000-303014, in which pigment derivatives are adsorbed onto the surface of pigment particles via treatment such as milling, and the method described in JP-A Nos. 2002-17997 and 2002-20141, in which after dissolving pigments in solvents together with the pigment derivatives, recrystallization is performed in poor solvents. By employing any of the above methods, it is possible to easily prepare pigment particles having a polar group on the surface.

In the present invention, the polar group may be free or in the form of salts, or may have a counter salt. Examples of the counter salts include inorganic salts (lithium, sodium, potassium, magnesium, calcium, aluminum, nickel, or ammonium) as well as organic salts (trimethylammonium, diethylammonium, pyridinium, or triethanolammonium). Univalent counter salts having as are preferred.

Preferred synergists are those which have been subjected to acidic modification such as sulfonic acid modification or carboxylic group modification, and which exhibit a larger amine value than the acid value.

The added amount, of these synergists is preferably 1-50 parts by weight with respect to 100 parts by weight of C.I. Pigment Red 122.

C. I. Pigment Red 122 is dispersed to result in an average diameter of pigment particles of 80-150 μm by appropriately selecting dispersing agents and dispersing media, as well as suitably setting the dispersing conditions and filtering conditions. It is possible to determine the average diameter via laser scattering. By the above management of particle diameter, in ink-jet printing, clogging of head nozzles is retarded and clogging of anilox rollers of a flexographic printer and cylinder rollers employed in gravure printing is minimized, whereby it is possible to maintain the desired storage stability of ink, transparency of ink, and the desired curing rate.

In the ink composition of the present invention, the concentration of C.I. Pigment Red 122 is preferably 1-20% by weight with respect to the total ink composition. Specifically, when employed in ink-jet recording, the above concentration is preferably 1-10% by weight.

### (Other Additives)

Other than the constituting elements described above, it is possible to incorporate water and basic compounds into the ink composition of the present invention.

By incorporating the basic compounds, the discharge stability of the ink composition of the present invention is enhanced and formation of wrinkles due to curing contraction is also retarded, even under low humidity.

Employed as such basic compounds may be any of the appropriate compounds known in the art. Representative ones include basic alkaline metal compounds, basic alkaline earth metal compounds, and basic organic compounds such as amine.

Basic alkaline metal compounds include hydroxides of alkaline metals (for example, lithium hydroxide, sodium hydroxide, and potassium hydroxide), carbonates of alkaline metals (for example, lithium carbonate, sodium carbonate, and potassium carbonate), and alkolates of alkaline metals (for example, sodium methoxide, sodium ethoxide, potassium methoxide, and potassium ethoxide).

The above basic alkaline earth metal compounds similarly include hydroxides of alkaline earth metals (for example, magnesium hydroxide and calcium hydroxide), carbonates of alkaline earth metals (for example, magnesium carbonate and calcium carbonate), and alkolates of alkaline earth metals (for example, magnesium methoxide).

Basic organic compounds include nitrogen-containing heterocyclic ring compounds such as amine, quinoline, and quinolidine. Of these, in view of compatibility with photopolymerization synthesis monomers, preferred are amines. Examples of the above amines include octylamine, naphthylamine, xylenediamine, dibenzylamine, diphenylamine, dioctylamine, dimethylaniline, quinuclidine, tributylamine, trioctylamine, tetramethylethylenediamine, tetramethyl-1,6-hexamethylenediamine, hexamethylenetetramine, and triethanolamine.

When the basic compounds are employed, their concentration is commonly in the range of 10-1,000 ppm by weight with respect to the total weight of the cationically polymerizable compounds, but is more preferably in the range of 20-500 ppm by weight. In addition, these basic compounds may be employed individually or in combinations of a plurality of them.

In the present invention, further simultaneously employed may be photolytically radical generating agents. Usable photolytically radical generating agents include conventional photolytically radical generating agents such as aryl alkyl ketone, oxime ketone, thiobenzoic acid S-phenyl, titanocene, aromatic ketone, thioxanthone, benzyl and quinone derivatives, or ketocoumarins. These are detailed in “UV•EB Koka Gijutsu no Oyo to Shijo (Applications of UV·EB Curing Technologies and Their Markets)”, supervised by Yoneho Tabata and edited by Radotech Xenkyu Kai, CMS Shuppan). Of these, acylphosphine oxide and acyl phosphonate are particularly effective for internal curing of ink images having a thickness of 5-12 μm per color as seen in ink-jet systems, since they exhibit a high sensitivity and result in a decrease in absorption due to photolytical cleavage of initiators. Specific examples include bis(2,6-dimethoxybenzoyl)-phenylphosphine oxide and bis(2,6-dimethoxybenzoyl)-2,4,4-trimethyl-pentylphosphine oxide.

Appropriately employed as the radical generating agent are 1-hydroxy-cyclohexyl-ketone, 2-methyl-1[4-(methylthio)phenyl]-2-morpholinopropane-1-one, bis(2,6-dimethoxybenzoyl)-2,4,4-trimethyl-pentylphosphine oxide, and 2-hydroxy-2-methyl-1-phenyl-propane-1-one (DARGCORE 1173). The added amount is preferably 1-6% by weight with respect to the total ink composition, but is more preferably 2-5% by weight,

### (Storage Container)

In view of a decrease in effects due to temperature, external light, heat, and ambient air during storage over an extended period of time, the ink composition of the present invention is characterized in that it is filled in a storage container which enables tightly sealed storage. It is preferable that the container employed for such tightly sealed storage is composed of materials which exhibit low air or moisture permeability.

Namely, a preferred embodiment of the container which realizes tightly sealed storage follows. The storage container of the active energy ray-curable ink composition, described in aforementioned embodiment 5, is characterized in that it is composed of the materials exhibiting low air or moisture permeability, which is described in JP-A No. 2005-15551.

It is preferable that the storage, container of the ink composition of the present invention is composed of metal or glass which substantially exhibits almost no moisture permeability, or plastic materials which exhibit moisture permeability of at most 20 g/m²·24 hours at a thickness of 25 μm, at 40° C., and 90% relative humidity under normal pressure. The moisture permeability of the plastic materials is preferably 0.01-20 g/m²·24 hours, but is more preferably 0.01-10 g/m²·24 hours. In the present invention, it is essential that a tight seal is gained by employing, in addition to the main body of the container, a lid which exhibits moisture permeability within the range specified above.

It is possible to determine the moisture permeability specified in the present invention, employing the method specified in JIS Z 0208 or ASTM E96. In these methods, a 25 μm thick test piece is held in a cup in which desiccants are placed, and the resulting cup is allowed to stand in a specified hydrothermostat (in the present invention, 40° C. and 90% relative humidity) over a specified period (in the present invention, 24 hours). The change of weight due to absorption by the desiccants prior to and after storage is determined, whereby it is possible to obtain the moisture permeability.

Further, in the storage method of the ink composition of the present invention, storage is carried out preferably at a content of the cationically polymerizable composition of at least 0.2% by weight, more preferably at a content of the same of 0.2-5.0% by weight, further more preferably at a content of the same of 0.3-3.0% by weight, but most preferably at a content of the same of 0.5-2.0% by weight.

It is possible to determine the moisture content of the cationically polymerizable composition according to the present invention via the Karl Fischer Method. In practice, a cationically polymerizable composition, of which moisture content is to be determined, is rehumidified at 10° C. and 30% relative humidity for at least 24 hours, and the weight of the resulting cationically polymerizable composition is accurately determined. Thereafter, the moisture quantity (as its weight) is determined employing a Karl Fischer moisture meter, and the moisture weight/the weight of the cationically polymerizable composition×100 is designated as the moisture content of the cationically polymerizable composition.

The storage container of the present invention will now be detailed.

The shape of the storage container of the ink composition of the present invention is not particularly limited, which include a bottle type, a cubic type, and a pillow type, as long as, it is composed, as described above, of substantially non-moisture permeable metals and glass, as well as plastic materials which exhibit a moisture permeability of at most 20 g/m²·24 hours at a thickness of 25 μm, and 40° C. and 90% relative humidity under normal pressure. The container may be formed employing a sheet composed of a low moisture permeable plastic, a sheet which is prepared of laminating metal foil such as aluminum onto the above sheet, a sheet prepared employing vapor deposition of metals such as aluminum, or a laminated sheet which is prepared by adhesion of plastic materials onto these sheets. These sheets may be employed individually or in combination to form the container.

In practice, any of the materials may be employed to form the storage container as long as they are tightly sealable. It is possible to list glass, metal or plastic containers. However, in view of durability, impact resistance, light weight, ease of conveyance, and cost, plastic containers are preferred.

Listed as plastic materials may be polyethylene (PS), polypropylene (PP), polystyrene (PS), polymethyl methacrylate (PMMA), biaxially oriented nylon 6, polyethylene terephthalate (PET), polycarbonate (PC), polyimide, and polyether styrene (PES).

Further, in the present invention, in view of realization of desired moisture permeability, it is preferable to employ low moisture permeable materials such as olefin based materials and fluorinated plastic materials.

As such materials, listed may, for example, be vinylidene chloride monomers, nylon 11, nylon 12, polychlorotrifluoroethylene, polytetrafluoroethylane, polyether ketone, and polyphenylene sulfide, as well as the aforesaid polypropylene, low density polyethylene (LDPB), and high density polyethylene.

In the present invention, when plastic materials are employed, it is preferable to employ materials of a moisture permeability of at most 20 g/m²·24 hours at a thickness of 25 μm. For example, they may be composite materials composed of a plurality of plastic materials as described in “Kinosei Hosozairyo no Shin Tenkai (Mew Development of Functional Packaging Materials)” (Toray Research Center Ltd.). Further, it is essential that a transparent flexible sheet is laminated onto the upper or one side via an inorganic material vapor-deposited layer, or at least, the innermost layer on one side is formed via thermoplastic resins.

Such inorganic material vapor deposited films include inorganic ones described on pages 879-901 of Hakumaku Handbook (Thin Film Handbook) (Japan Society for the Promotion of Science), pages 502-509, 612, and 810 of Shinku Gijutsu Handbook (Vacuum Technology Handbook) (Nikkan Kogyo Shinbun Ltd.), and pages 132-134 of Shinku Handbook (Vacuum Handbook), Revised Edition (ULVAC Ninon Shinku Gijutsu K.K.).

For example, employed are Cr₂O₃, SiₓO_{y} x=1 and y=1.5-2), Ta₂O₃, ZrN, SiC, TiC, PSG, Si₃N₄, single-crystal Si, amorphous Si, W, and Al₂O₃.

As examples of the multilayer structured plastic sheet prepared via adhesion of a plurality of plastic sheets, listed may be a 3-layer structure of polyethylene terephthalate/polyvinyl alcohol-ethylene copolymer/polyethylene, a 3-layer structure of oriented polypropylene/polyvinyl alcohol-ethylene copolymer, a 3-layer structure of non-oriented polypropylene/polyvinyl alcohol-ethylene copolymer/polyethylene, a 3-layer structure of nylon/aluminum foil/polyethylene, a 3-layer structure of polyethylene terephthalate/aluminum foil/polyethylene, a 4-layer structure of cellophane/polyethylene/aluminum foil/polyethylene, a 3-layer structure of aluminum foil/paper/polyethylene, a 4-layer structure of polyethylene terephthalate/polyethylene/aluminum foil/polyethylene, a 4-layer structure of nylon/polyethylene/aluminum foil/polyethylene, a 4-layer structure of paper/polyethylene/aluminum foil/polyethylene, a 4-layer structure of polyethylene terephthalate/aluminum foil/polyethylene terephthalate/polypropylene, a 4-layer structure of polyethylene terephthalate/aluminum foil/polyethylene terephthalate/high density polyethylene, a 4-layer structure of polyethylene terephthalate/aluminum foil/polyethylene/low density polyethylene, a 2-layer structure of polyvinyl alcohol-ethylene copolymer/polypropylene, a 3-layer structure of polyethylene terephthalate/aluminum foil/polypropylene, and a 3-layer structure, of paper/aluminum foil/polyethylene. As examples of the particularly preferred ones listed may be the 4-layer structure of polyethylene/polyvinylidene chloride-covered nylon/polyethylene/ethylvinyl acetate-polyethylene condensation product, the 3-layer structure of polyethylene/polyvinylidene chloride-covered nylon/polystyrene, the 5-layer structure of ethylvinyl acetate-polyethylene condensation product/polyethylene/aluminum-deposited nylon/polyethylene/ethylvinyl acetate-polyethylene condensation product, the 4-layer structure of aluminum-deposited nylon/nylon/polyethylene/ethylvinyl acetate-polyethylene condensation product, the 3-layer structure of oriented polypropylene/polyvinylidene chloride-covered nylon/polyethylene, the 5-layer structure of polyethylene/polyvinylidene chloride-covered nylon/polyethylene/polyvinylidene chloride-covered nylon/polyethylene, the 3-layer structure of oriented polypropylene/polyvinyl alcohol-ethylene copolymer/low density polyethylene, the 3-layer structure of oriented polypropylene/polyvinyl alcohol-ethylene copolymer/non-oriented polypropylene, the 3-layer structure of polyethylene terephthalate/polyvinyl alcohol-ethylene copolymer/low density polyethylene, the 3-layer structure of oriented nylon/polyvinyl alcohol-ethylene copolymer/low density polyethylene, and the 3-layer structure of non-oriented nylon/polyvinyl alcohol-ethylene copolymer/low density polyethylene.

In order to prepare the storage container composed of materials which exhibit a moisture permeability of at most 20 g/m²·24 hours at a thickness of 25 mu, it is possible to prepare a storage container which exhibits the targeted moisture permeability via appropriate selection of the above listed materials. Further, the storage container of the present invention may be composed of a single configuration. However, if desired, for example, the following configuration also is acceptable. After placing a cationically polymerizable composition in a bottle type container, its outside is further sealed employing moisture-proof sheet composed of a multilayer-structured plastic sheet.

### (Ink-Jet Recording Method)

The active energy ray-curable ink composition of the present invention results in less limitation for recording media for printing, and enables application to various uses. It is possible to apply to wide printing fields such as ink-jet recording systems, flexographic printing, or gravure printing.

Recording media, which are applicable to image formation employing the active energy ray-curable ink composition of the present invention, include common non-coated paper, and coated paper, as well as various non-absorptive plastics and films thereof, which are employed to so-called soft packaging. As various plastic films listed may, for example, be polyethylene terephthalate (PET) film, oriented polystyrene (OPS) film, oriented polypropylene (OPP) film, oriented nylon (ONy) film, polyvinyl chloride (PVC) film, polyethylene (PS) film, and triacetyl cellulose (TAC) film. Further, metals and glass are applicable. Of these recording media, specifically, when images are formed on PET film, OPS film, OPP film, ONy film, or PVC film which are all shrinkable via heat, embodiments of the present invention become effective. These substrates tend to result in film curling and deformation due to curing contraction of the ink and heat which is generated during the curing reaction, and in addition, the resulting ink film tends to not accept the contraction of the substrate.

The surface energy of each, of the various plastic films significantly differs from each other due to the component characteristics, whereby heretofore, problems have occurred in which the dot diameter after ink deposition changes, in the embodiment of the present invention, it is possible to form desired highly detailed images on a wide range of recording materials of a wide range of surface energy of 35-60 mN/m, including OPP film and OPS film which exhibit relatively low surface energy, and PET which exhibits relatively high surface energy.

In the present invention, in view of packaging cost, rerecording medium cost such as production cost, print production efficiency, and capability corresponding to various sizes, it is more advantageous to employ long-length (web) recording medium.

With regard to an ink-jet recording system, which is specifically preferred as an image forming method employing the active energy ray-curable composition of the present invention, in which the active energy ray-curable ink composition of the present invention is discharged onto a recording medium to form images and subsequently the ink is cured via exposure to an active light rays such as ultraviolet rays, detailed will be printing compositions, light exposing conditions, exposure light sources, and an ink-jet recording apparatus.

(Total Ink Film Thickness after Ink Deposition)

In the recording method employing the active energy ray-curable ink of the present invention, the total ink film thickness after ink deposition onto a recording medium and curing via exposure to active light rays is preferably 2-25 μm. In the active light ray-curable type ink-jet recording in screen printing fields, the current situation is that the total ink film thickness exceeds 25 μm. However, in the soft package printing field where recording media are frequently composed of thin plastic materials, in addition to curling and wrinkling problems of the above recording media, a problem results in which stiffness and feeling of quality are changed. Accordingly, ink discharge which results in excessive thickness is not preferred.

“Total ink film thickness”, as described herein, refers to the maximum value of the thickness of the ink film for formation of image on the recording medium, and is as defined for a single color, as well as cases of 2-color overlapping, 3-color overlapping, and 4-color overlapping (white ink base) which are practiced in recording employing ink-jet recording systems.

### (Ink Discharge Conditions)

As ink discharge conditions, in view of discharge stability, it is preferable that recording heads and inks are heated to 35-100° C. followed by discharge. Active light ray-curable type inks exhibit a wide range of viscosity variation due to temperature change, and viscosity variation significantly affects the size and ejection rate of ink droplets to result in degradation of the resulting image quality. Consequently, it is essential to maintain the temperature of inks after reaching a specified temperature. The control range of the ink temperature is commonly specified temperature ±5° C., is preferably specified temperature ±2° C., but is still more preferably specified temperature ±1° C.

Further, in the ink-jet recording method employing the ink composition of the present invention, droplet volume discharged from each nozzle is preferably 3-15 pl. By nature, to form highly detailed images, the droplet volume is required to be within the above range. However, when discharge is conducted at the above ink droplet volume, the above discharge stability is increasingly demanded. According to the present invention, even when discharge is conducted at an ink droplet volume as small as 2-15 pl, discharge stability is enhanced, and it enables stable formation of highly detailed images.

(Light Exposure Conditions after Ink Deposition)

In the image forming method based on an ink-jet recording method employing the ink composition of the present invention, as exposure conditions of active light rays, the active light rays are preferably exposed 0.001-1.0 second after ink deposition, but are more preferably exposed 0.001-0.5 second. To form highly detailed images, it is essential that exposure occurs as soon as possible.

A basic method of the exposure methods of active light rays is disclosed in JP-A No. 60-132767. In the above method, light sources are arranged on both sides of a head unit, and the head is scanned via a shuttle system. Thus, exposure is conducted during an elapse of a definite period after ink deposition. Further, curing is completed via another light source which is not driven. U.S. Pat. No. 6,145,079 discloses an exposure method which employs optical fibers, and another method in which collimated light beams are made to be incident to a specular surface provided on the side of the head unit and then UV beams are exposed onto the recording section. In the image forming method based on an ink-jet recording method employing the ink composition of the present invention, employed may foe any of these exposure methods.

Further, the following method is one of the preferred embodiments. Active light ray exposure is divided into two stages, and initially, active light rays are exposed during 0.001-2.0 seconds after ink deposition based on the above method, and after completion of whole printing, active light rays are further exposed onto it. By dividing the active light ray exposure into two stages, it is possible to minimize contraction of recording media, which tends to occur during curing of the ink.

Heretofore, in UV ink-jet systems, in order to retard dot spreading and bleeding after ink deposition, it has been common that light sources of high illuminance are used, which exceed a total power consumption of 1 kW·hour. However, currently when such light sources are employed, during printing on shrink labels, the contraction of recording media is too great making impractical to employ the above light source.

In the image forming method employing the ink composition of the present invention, it is preferable to employ active light rays exhibiting the maximum illuminance in the wavelength range of 254 nm, whereby even when a light source of a total power consumption of at least 1 kW·hour is employed, it is possible to form highly detailed images and to regulate the contraction of recording media within a practically permissible level.

In the image forming method employing the ink composition of the present invention, it is further preferable that the total power consumption of light sources which emit active light rays is less than 1 kW·hour. Examples of such light sources, which result in the total power consumption of less than 1 kW·hour, include fluorescent lamps, cold-cathode tubes, hot-cathode tubes, and LEDs.

### EXAMPLES

The present invention will be specifically described with reference to examples, however the present invention is not limited thereto. In the examples, representations of “parts” and “%” are employed, and each of them represents “parts by weight” or “% by weight” unless otherwise specified.

### <<Preparation of Pigment Dispersion>>

### (Preparation of Pigment Dispersion D-1)

Each of the following compounds was placed in a stainless steel beaker and while stirring, dissolution, was achieved over one hour upon being heated on a hot plate at 65° C.

| | |
|---|---|
| PB821 (polymer dispersing agent, produced by | 14 parts |
| Ajinomoto-Fine-Techno Co., Inc.) | |
| Oxetane compound OXT221: bis(3-ethyl-3- | 58 parts |
| oxetanylmethyl)ether, produced by | |
| TOAGOSEI Co., Ltd.) | |

Subsequently, after cooling the above solution to room temperature, 28 parts of C.I. Pigment 122 were added, and the resulting mixture was placed in a glass bottle together with 200 g of 1 mm diameter zirconia beads. The bottle was tightly sealed. After dispersing the resulting mixture over two hours employing a paint shaker, the zirconia beads were removed, whereby Pigment Dispersion D-1 was prepared.

### (Preparation of Pigment Dispersion D-2)

Each of the following compounds was placed in a stainless steel beaker, and while stirring, dissolution was achieved over one hour upon being heated on a hot plate at 65° C.

| | |
|---|---|
| PB821 (polymer dispersing agent, produced by | 14 parts |
| Ajinomoto-Fine-Techno Co., Inc.) | |
| Vinyl ether compound VE-1: triethylene glycol | 58 parts |
| divinyl ether | |

Subsequently, after cooling the above solution to room temperature, 28 parts of C.I. Pigment 122 were added, and the resulting mixture was placed in a glass bottle together with 200 g of 1 mm diameter zirconia beads, followed by tightly sealing the bottle. After dispersing the resulting mixture over two hours employing a paint shaker, the zirconia beads were removed, whereby Pigment. Dispersion D-2 was prepared.

### (Preparation of Pigment Dispersion D-3)

Each of the following compounds was placed in a stainless steel beaker and while stirring, dissolution was achieved for one hour upon being heated on a hot plate at 65° C.

| | |
|---|---|
| PB821 (polymer dispersing agent, produced by | 14 parts |
| Ajinomoto-Fine-Techno Co., Inc.) | |
| Vinyl ether compound VE2: 1,3-cyclokexanediol | 58 parts |
| divinyl ether | |

Subsequently, after cooling the above solution to room temperature, 28 parts of C.I. Pigment 122 were added, and the resulting mixture was placed in a glass bottle together with 200 g of 1 mm diameter zirconia beads. The bottle was tightly sealed. After dispersing the resulting mixture over two hours employing a paint shaker, the zirconia beads were removed, whereby Pigment Dispersion D-3 was prepared,

### (Preparation of Pigment Dispersion D-4)

Pigment Dispersion D-4 was prepared in the same manner as above Pigment Dispersion D-3, except that C.I. Pigment 122 was replaced with C.I. Pigment Violet in the same amount.

### <<Preparation of Ink Compositions>>

Ink Compositions 1-21, which were, constituted as described in Tables 1, 2, and 3, were prepared employing each of the pigment dispersions prepared as above.

### {Preparation of Ink Composition 1}

| | |
|---|---|
| Pigment Dispersion D-1 (pigment | 12.5 parts |
| concentration: 28%, OXT221 | |
| concentration: 58%, and PB821 | |
| concentration: 14%) | |
| Epoxy compound: EP-A (3,4- | 26.9 parts |
| epoxycyclohexylmethy1-3′,4′- | |
| epoxycylohexane carboxylate) | |
| Oxetane compound: OXT221 (bis(3-ethyl-3- | 55.5 parts |
| oxetanylmethyl)ether) | |
| Photopolymerization initiator: UV16992 | 5.0 parts |
| (produced by Dow Chemical Co.) | |
| Triethanolamine | 0.10 part |

After blending the above additives, in order to minimize clogging in printers, the resulting mixture was filtered through a 1.0 μm membrane filter, whereby Ink Composition 1 was prepared.

In above Ink Composition 1, the addition amount ratio of BP-1 and OXT221, which were cationically polymerizable compounds, was 30:70.

### (Preparation of Ink Compositions 2-22)

Ink Compositions 2-22 were prepared in the same manner as above Ink Composition 1, except that the types of pigment dispersions, the cationically polymerizable compounds, and added amounts were changed as listed in Tables 1, 2, and 3. The total amount of cationically polymerizable compounds, which were employed during preparation of pigment dispersions, was regulated to be 89.6 parts. Further, in. Tables 1, 2, and 3, the weight ratio of each cationically polymerizable compound was listed in a total amount of 89.6 parts.

Each of the compounds represented by abbreviations in Table 1, 2, and 3, will now be detailed.

### (Pigments)

PR122: C.I. Pigment Red 122
PV19: C.I. Pigment Violet 19

### (Cationically Polymerizable Compounds)

### <Vinyl Ether Compounds>

VE-1: triethylene glycol divinyl ether
VE-2: 1,3-cyclohexanediol divinyl ether

### <Oxetane Compounds>

OXT221: bis(3-ethyl-3-oxetanylmethyl)ether
OXT101:3-ethyl-3-hydroxyethyloxetane

### <Epoxy Compound>

EP-A; 3,4-epoxycyclohexylmethyl-3′,4′-epoxycyclohexane carboxylate
EP-B: Exemplified Compound BP-10

### (Photopolymerization Initiator)

UV16992: produced by Dow Chemical Co.

### (Amine Compound)

TEA: triethanoiamlne

### <<Evaluation of Ink Compositions<<

### (Evaluation of Discharge Stability)

### (Pre-Treatment of Ink Compositions)

After placing each of the ink composition prepared as above in a glass container, it was sealed with a lid. The tightly sealed container was placed in a thermostat at approximately 70° C. for one week, whereby an accelerated aging treatment was conducted.

### (Discharge Test)

Each of the ink compositions which had been subjected to the above accelerated aging treatment and which had not been subjected to the same was continuously discharged at an ambience of 23° C. and 55% relative humidity for 30 minutes from the head of the ink-jet printer produced by Xaar Co. Thereafter, the ejection state of the ink composition from each nozzle of the recording head was visually observed, and ejection of the ink compositions which had been subjected to the accelerated aging treatment and had not been subjected to the same was determined, based on the following criteria and discharge stability and storage stability were evaluated.
A: when ejection was continued for 30 minutes, no nozzle lacking was generated
B: when ejection was continued for 30 minutes, no nozzle lacking was generated, but a few satellites were generated
C: when ejection was continued for 30 minutes, nozzle lacking and satellites were slightly generated
D: nozzle lacking and satellites were significantly generated, and it was not possible to conduct stable ejection

TABLE 1

Pigment Dispersion

| Ink | | | Cationic | Added |
|---|---|---|---|---|
| Composition | | Pigment | Polymerizable | Amount |
| No. | No. | Type | Compound | (parts) |
| 1 | D-1 | PR122 | OXT221 | 12.5 |
| 2 | D-1 | PR122 | OXT221 | 12.5 |
| 3 | D-2 | PR122 | VE-1 | 12.5 |
| 4 | D-2 | PR122 | VE-1 | 12.5 |
| 5 | D-2 | PR122 | VE-1 | 12.5 |
| 6 | D-2 | PR122 | VE-1 | 12.5 |
| 7 | D-3 | PR122 | VE-2 | 12.5 |
| 8 | D-3 | PR122 | VE-2 | 12.5 |
| 9 | D-3 | PR122 | VE-2 | 12.5 |
| 10 | D-3 | PR122 | VE-2 | 12.5 |
| 11 | D-3 | PR122 | VE-2 | 12.5 |
| 12 | D-3 | PR122 | VE-2 | 12.5 |
| 13 | D-3 | PR122 | VE-2 | 12.5 |
| 14 | D-3 | PR122 | VE-2 | 12.5 |
| 15 | D-3 | PR122 | VE-2 | 12.5 |
| 16 | D-3 | PR122 | VE-2 | 12.5 |
| 17 | D-3 | PR122 | VE-2 | 12.5 |
| 18 | D-3 | PR122 | VE-2 | 12.5 |
| 19 | D-3 | PR122 | VE-2 | 12.5 |
| 20 | D-4 | PV19 | VE-2 | 12.5 |
| 21 | D-4 | PV19 | VE-2 | 12.5 |
| 22 | D-4 | PV19 | VE-2 | 12.5 |

TABLE 2

| | Cationic Polymerizable Compound: Total | | | | | |
|---|---|---|---|---|---|---|
| | Added Amount = 82.4 Parts | | | | | |
| | Ratio of Added Amount of Each Cationic | | | | | |
| | Polymerizable Compound (% by weight) | | | | | |
| Ink | Vinyl | | Epoxy | | Oxetane | |
| Composition | Ether | | Compound | | Compound | |
| No. | VE-1 | VE-2 | EP-A | EP-B | OXT221 | OXT101 |
| 1 | — | — | 30 | — | 70 | — |
| 2 | — | — | — | 30 | 60 | 10 |
| 3 | 100 | — | — | — | — | — |
| 4 | 70 | — | 30 | — | — | — |
| 5 | 47 | — | 53 | — | — | — |
| 6 | 30 | — | 70 | — | — | — |
| 7 | — | 100 | — | — | — | — |
| 8 | — | 70 | 30 | — | — | — |
| 9 | — | 47 | 53 | — | — | — |
| 10 | — | 30 | 70 | — | — | — |
| 11 | — | 70 | — | 30 | — | — |
| 12 | — | 47 | — | 53 | — | — |
| 13 | — | 30 | — | 70 | — | — |
| 14 | — | 70 | — | — | 30 | — |
| 15 | — | 47 | — | — | 53 | — |
| 16 | — | 30 | — | — | 70 | — |
| 17 | — | 70 | — | — | — | 30 |
| 18 | — | 47 | — | — | — | 53 |
| 19 | — | 30 | — | — | — | 70 |
| 20 | — | 100 | — | — | — | — |
| 21 | — | 70 | — | — | 30 | — |
| 22 | — | 30 | — | — | 70 | — |

TABLE 3

| | Photo- | | | | |
|---|---|---|---|---|---|
| Ink | polymerization | | | | |
| Compo- | Initiator | Amine | Ejection | | |
| sition | UV16992 | Compound | Before | After | |
| No. | (parts) | (parts) | Storage | Storage | Remarks |
| 1 | 5.0 | 0.10 | D | D | Comp. |
| 2 | 5.0 | 0.10 | D | D | Comp. |
| 3 | 5.0 | 0.10 | A | A | Inv. |
| 4 | 5.0 | 0.10 | A | A | Inv. |
| 5 | 5.0 | 0.10 | A | B | Inv. |
| 6 | 5.0 | 0.10 | C | C | Comp. |
| 7 | 5.0 | 0.10 | A | A | Inv. |
| 8 | 5.0 | 0.10 | A | B | Inv. |
| 9 | 5.0 | 0.10 | B | B | Inv. |
| 10 | 5.0 | 0.10 | D | D | Comp. |
| 11 | 5.0 | 0.10 | A | A | Inv. |
| 12 | 5.0 | 0.10 | A | A | Inv. |
| 13 | 5.0 | 0.10 | C | C | Comp. |
| 14 | 5.0 | 0.10 | A | A | Inv. |
| 15 | 5.0 | 0.10 | A | A | Inv. |
| 16 | 5.0 | 0.10 | B | C | Comp. |
| 17 | 5.0 | 0.10 | A | A | Inv. |
| 18 | 5.0 | 0.10 | A | A | Inv. |
| 19 | 5.0 | 0.10 | B | C | Comp. |
| 20 | 5.0 | 0.10 | C | D | Comp. |
| 21 | 5.0 | 0.10 | C | D | Comp. |
| 22 | 5.0 | 0.10 | C | D | Comp. |

Comp.: Comparative Example,
Inv.: Present Invention

As can clearly be seen from the results described in Tables 1, 2, and 3, the ink composition of the present invention, which incorporates at least a vinyl ether compound as a cationically polymerizable compound in an amount of at least 45% by weight with respect to the total cationically polymerizable compounds and C.I. Pigment Red 122 as a pigment, exhibited excellent discharge stability and storage stability in such a manner that even after storage for an extended period of time at a filled state in a tightly sealed container, excellent discharge stability was maintained, compared to the comparative examples.

1-6. (canceled)

7. An active energy ray-curable ink composition comprising an active light ray-curable cationically polymerizable compound and a pigment, wherein the cationically polymerizable compound is a vinyl ether compound, the content of the vinyl ether compound is a least 45% by weight with respect to the total of the cationically polymerizable compound, and the pigment is C.I. Pigment Red 122.

8. The active energy ray-curable ink composition of claim 7, wherein the ink composition further comprises a sensitizers absorbing ultraviolet ray spectra at a wavelength equal to or longer than 300 nm.

9. The active energy ray-curable ink composition of claim 7, wherein C.I. Pigment Red 122 has been dispersed by a polymer dispersing agent.

10. The active energy ray-curable ink composition of claim 7, wherein C.I. Pigment Red 122 is subjected to a surface treatment.

11. The active energy ray-curable ink composition of claim 9, wherein C.I. Pigment Red 122 is subjected to a surface treatment by employing synergist.

12. The active energy ray-curable ink composition of claim 7, wherein C.I. Pigment Red 122 has an average diameter of pigment particles of 80-150 μm.

13. The active energy ray-curable ink composition of claim 7, wherein the vinyl ether compound is a compound represented by following Formula (A);
R₁-X-(R₂)ₙ Formula (A)
wherein R₁ represents a vinyl ether containing group, R₂ represents a substituent, X represents a ring structure containing group, and “n” represents an integer of 0 or higher.

14. The active energy ray-curable ink composition of claim 7, wherein a cationic polymerization initiator is further incorporated.

15. The active energy ray-curable ink composition of claim 7, wherein an oxirane ring containing compound or an oxetane ring containing compound is incorporated as the cationically polymerizable compound.

16. A storage container of an active energy ray-curable ink composition, wherein the active energy ray-curable ink composition of claim 7 is incorporated.

17. A storage method of an active energy ray-curable ink composition wherein the storage container of an active energy ray curable ink composition of claim 7 is employed.
